(19) United States
(12) Patent Application Publication
(10) Pub. No.: US 2006/0264553 A1
(43) Pub. Date: Nov. 23, 2006

(54) Extrusion method for the production f strength-modified and phyllosilicate reinforced thermoplastic systems

(76) Inventor: Jozsefne Karger-Kocsis, Kaiserslautern (DE)

Correspondence Address: PAUL AND PAUL, 2000 MARKET STREET, SUITE 2900, PHILADELPHIA, PA, 19103, US

(21) Appl. No.: 10/576,404

(22) PCT Filed: Sep. 15, 2004
(86) PCT No.: PCT/EP04/52189

§ 371 Date: Apr. 20, 2006

(30) Foreign Application Priority Data
Oct. 20, 2003 (DE) 103485481

(51) Int. Cl. C08K 3/34

(52) U.S. Cl. 524/442

(57) ABSTRACT

This invention relates to and extrusion method for the production of strength-modified and phyllosilicate-reinforced thermoplastic systems. According to the invention, a production method for nanocomposite materials, using the most economic raw materials, which may be easily worked and which do not require a complicate prepartion before processing and with establishment of a starting material composition which meets the requirements for a high-performance nanocomposite material, in particular, with regard to rigidity and strength, may be achieved, whereby a strength modifier in the form of a phyllosilicate is added to the compounded system as an essentially aqueous dispersion and the water is at least partly removed from the compounded system during the extrusion.

The present invention relates to an extrusion process for the preparation of toughness-modified and layered silicate-reinforced thermoplastic systems.

Lightweight construction materials are becoming increasingly important across various sectors, to spare natural resources. A decisive factor is that the weight advantages are associated with good and improved mechanical properties. One approach to meeting these requirements is nanocomposites, in which suitable materials are incorporated as nanoparticles into different matrices. The level of filling and the particle size can vary, and it is decisive that the composites have a very fine and homogeneous particle distribution in the matrix.

The processes during the incorporation of nanoparticles take place at molecular level. Consequently, in addition to appropriately optimized process technology, the mutual compatibility of the nanoparticles with the composite is important.

Natural and synthetic layered silicates are nanoparticles known from the state of the art which, while they increase the rigidity of the material, can however be finely distributed, i.e. as separate nanoparticles sheathed in the matrix, only at great cost. Being larger macroparticles, they increase the rigidity only moderately, and in the process simultaneously reduce the impact strength.

In order to achieve an increase in toughness, rubber particles are used among others for the improvement of plastics, but their presence is at the cost of rigidity. Nanocomposites would therefore be desirable which are optimized with regard to material rigidity and impact strength.

An improvement in the properties of the above composites is offered by processes for the preparation of layered silicate-reinforced composites such as, for one, the exfoliation and adsorption process in which layered silicates and polymers in the same solvents are dispersed or dissolved in the same solvent, wherein polymer and unfolded exfoliated layered silicates lie against one another and after evaporation of the solvent form a multi-layer sandwich structure.

A further process is intercalating polymerization in situ. In this process the layered silicate is soaked in the liquid monomer or a solution of the monomer of the matrix material, and the formation of the polymer can in this way take place between the intercalated sheets of the layered silicate. The polymerization can be initiated by an initiator substance or for example by irradiation or heat treatment.

During the melt intercalation the layered silicates are mixed together with the polymer matrix in the melted state. Under these conditions, if layered silicates and polymers are ideally matched to one another, the polymer can migrate into the interstices of the layered silicates and thus lead to the formation of either intercalated or exfoliated nanocomposites (Alexandre, M. and Dubois, P., Polymer-layered Silicate Nanocomposites: Preparation, Properties and Uses of a new Class of Materials, Materials Science and Engineering Reviews 28 (2000) 1-36). No solvent is required with this method.

Within the framework of the present invention, only composites with suitably finely distributed filling materials are called “nanocomposites”, because the particles of at least one filler which are individually surrounded by matrix materials have measurements only of the order of nanometres in at least one dimension.

It is known from the state of the art that melt intercalation can be carried out in an extruder. Thus Liu et al. 1999 prepared a nanocomposite on the basis of nylon and using montmorillonite (Liu, L. M. et al., Studies on Nylon-6 Clay Nanocomposites by Melt-Intercalation Process, J. Appl. Polym. Sci. 71 (1999) 1133-1138). In order to be able to carry out this process it was necessary to make the strongly polar layered silicates compatible with the polymer matrix beforehand by cation exchange with organic apolar cations. This preparation of organically modified layered silicates is very time-consuming and cost-intensive.

There is thus a need for processing technology in which layered silicates or even other minerals can also be used without chemical pretreatment as nanofillers.

Therefore, the object of the present invention is to provide a preparation process for nanocomposites which operates with raw materials to be obtained on the most favourable terms possible which can be easily processed and which do not require elaborate preparation before processing. In this connection another object of this invention is to establish for this a combination of raw materials which satisfies the requirements of a high-performance nanocomposite, primarily in respect of rigidity and toughness.

These objects are achieved according to the present invention by an extrusion process for the preparation of toughness-modified and layered silicate-reinforced thermoplastic systems, characterized in that both toughness modifier and layered silicate are introduced in substantially aqueous dispersion into the compounding system and in that the water is removed at least in part from the compounding system during the extrusion.

The advantage when using an aqueous silicate solution is that the multilayer silicates swell markedly in water, and the distance between the layers can increase by 40-50% and more. These enlarged interstices between the layers are therefore accessible to the polymer in question and the intercalation and exfoliation of the layered silicates is accordingly encouraged.

By introducing toughness modifiers in aqueous suspension the individual layers of the silicates can congregate with the particles of the toughness modifier to form elements which surprisingly improve resistance and strength (skeleton or house-of-cards structure). The at least partial and mostly extensive removal of the water from the compounding system leads to the optimum mixture compounding. It can also be advantageous if the water is completely removed for the following further processing, for example the granulation of the compound. Under certain circumstances it can, however, also be advantageous to keep a suitable quantity of water in the compound. When preparing products with a foam structure by direct extrusion (e.g. profile, sheets) the water can thus assume e.g. the function of a physical foaming agent.

Apart from this it is theoretically also possible for part of the introduced water to remain chemically or otherwise bonded in the compound.

The whole range of natural and synthetic polymers known from the state of the art comes into consideration as matrix, such as thermoplastics (for example polyethylene, polyester, polystyrene, polyvinylchloride, polyamides) elastomers (for example polyurethane, styrenebutadiene, ethylenepropylene, polychloropene, silicone) and natural rubber. Polyamides, linear polyesters (PET, PBT), polyoxymethylene and polyolefins (PE, PP) are particularly preferred. The layered silicates that can be used include all the representatives of the natural or synthetic swellable layered silicates. These include argillaceous stones and earths (for example bentonite and kaolinite), clay minerals (for example montmorillonite, beidellite, vermiculite, serpentine) and synthetic layered silicates (for example MgO(SiO₂)ₛ(Al₂O₃)ₐ(AB)_{b}(H₂O)ₓ, wherein AB is an ion pair, such as for example NaF). To modify the toughness of plastic for example natural rubber (such as for example natural rubber (NR)) or synthetic rubber (such as for example styrenebutadiene (SBR), nitrile rubber (NBR), polychloropene (CR)) can be used.

The layered silicates can be present in the polymer matrix as particles on the micro scale, but given suitable processing it is however the aim that the layered silicates of the polymer matrix are present intercalated or in exfoliated state, i.e. as individual layers which are embedded in the polymer matrix (nano scale).

In the context of the present invention the term dispersion covers a system comprising several phases, one of which is continuous and at least a further one finely dispersed, such as for example in the case of an emulsion, suspension or molecular dispersion.

In a preferred embodiment of the present invention the dispersions of toughness modifier and layered silicate are introduced temporally and/or spatially separated into the compounding system. The advantage with this process is that the dispersions are easier to handle separate, and no undesired interactions between the toughness modifier and the silicate layers can take place at this stage.

In another preferred embodiment of this invention toughness modifier and layered silicate are introduced together in the compounding system. It is advantageous that only one joint process step is necessary. This is tantamount to spending less on plant technology.

A further preferred embodiment of the present invention is characterized in that the water from the compounding system is removed during the extrusion by evaporation. The removal by evaporation of the water from the compounding system is recommended because the temperature in the mixture is already raised as a result of the extrusion and the mixing of the solutions and possibly in addition due to the introduction of the melt, and water can be evaporated with no, or only little, further expenditure on energy.

Dried rubber can be satisfactorily dispersed in water. An aqueous dispersion of rubber is called latex. Therefore, in a preferred embodiment of the present invention toughness modifiers which include natural and synthetic rubber and mixtures thereof are used, being employed in aqueous dispersion, i.e. as latex. The use of all the toughness modifiers dispersible in water is also conceivable according to the present invention. When suspending the rubber, it is to be ensured that the rubber particles are dispersed as finely as possible. The particle size should be in the range of <10 μm.

In a particularly preferred embodiment of the present invention the toughness modifiers used include latex and latex mixtures of natural rubbers (such as for example natural rubbers (NR)) or synthetic rubber (such as for example styrenebutadiene (SBR), nitrile rubber (NBR), polychloropene (CR)). The advantage when using latex is that here the rubber is already present in suspended form.

In a further particularly preferred embodiment of the present invention the latex or the latex mixture or the rubber or the rubber mixture is prevulcanized. Prevulcanization with e.g. sulphur or high-energy radiation is advantageous in order to retain the original particle size of the toughness modifier. Otherwise the particle size could change under the conditions during compounding according to compatibility with the matrix. Therefore prevulcanization is an important measure for the targeted control of particle size and distribution.

A further preferred embodiment of this invention is characterized in that the toughness modifier used has a particle size of 0.1-10 μm. The particle size and the distance of the particles from one another are very important for the formation of microcracks around the particles in the polymer matrix. Matrix molecules can grow into these microcracks and form microfibrils which bring about an extremely high toughness of the resulting composite. A very good toughness is thus achieved for example by particle diameters of approximately 0.5 μm and distances between these particles of 1-10 μm, particularly preferably approximately 2 μm.

According to a further preferred embodiment of the invention the toughness modifier is characterized in that the structure of the particles of the toughness modifier consists of a core and shell. Particles with a core (e.g. polystyrene) and shell (e.g. polyacrylate) structure have the advantage that, via the modifying of the shell, the difference in rigidity (E-modulus) between the rubber phase and the matrix can be varied. The stress concentration at the particles is thereby changed which determines to what extent cavities of the matrix form in the surroundings of the particles. This in turn is a decisive factor in increasing toughness.

In a particularly preferred embodiment the particles of the toughness modifier have reactive groups on their surface. Via these reactive groups these particles can interact with the functional groups of the respective matrix polymer and thereby create a chemical bond. Such reactive groups include hydroxyl, carboxyl and epoxy groups.

In a further particularly preferred embodiment the toughness modifier used is contained in the compounded product of the process in an amount of 1-40 wt.-%, preferably in an amount of 5-25 wt.-%. These concentrations deliver a product with optimum toughness.

In another preferred embodiment of the present invention the layered silicate used includes natural and synthetic layered silicates, such as for example bentonite and fluorohectorite which are swellable in water. While natural layered silicates are particularly favourably available, it is advantageous with synthetic layered silicates that they are particularly pure, which is of great advantage e.g. as regards thermal and thermooxidative stability.

A further preferred embodiment of the present invention is characterized in that the layered silicate in the compounded product of the process is contained in an amount of 1-10 wt.-%. The layered silicate in the compounded product of the process is preferably contained in an amount of 4-8 wt.-%. This concentration is optimal for the formation of single layers and for the homogeneous dispersion of these single layers in the matrix.

Compared with the processes known until now in the state of the art the process according to the present invention delivers a product which has optimum features with regard to toughness and rigidity. In conventional processes the introduction of layered silicates generally requires a chemical pretreatment in order to obtain a product with the desired properties. In this pretreatment the layered silicates are given “organophilic properties” by cation exchange in order to thus grant the compatibility of the originally very polar layered silicates with the matrix. This process step is customarily very time-consuming and expensive and according to the present invention advantageously not necessary.

The use according to the invention of rubber particles with polar surfaces is also advantageous, as the addition of a compatibility promoter was generally required for the incorporation of layered silicates into customarily unpolar plastics. The addition of such a polar-modified plastic, also called compatibilizer, is not necessary, with the preparation process according to the invention.

With the conventional process for preparing layered silicate-reinforced plastics the layered silicate is exfoliated or intercalated in the compound which is located in the extruder. A sufficient residence time of the mixture in the extruder is essential for this and the process according to the invention here delivers a further advantage in that this time is saved because the layered silicate is introduced already swollen into the extruder and can be more quickly exfoliated there.

In further preferred embodiments of the invention the substantially aqueous dispersion additionally contains up to a total of 50 vol.-% of polar, water-soluble organic compounds. These polar, water-soluble organic compounds include, among others, alcohols and glycols, but also water-soluble polymers, such as e.g. polyvinyl alcohol which can be advantageous as a thickener. Optionally, in a further embodiment cationic surfactants are added to the dispersion for the post-stabilization of the latex.

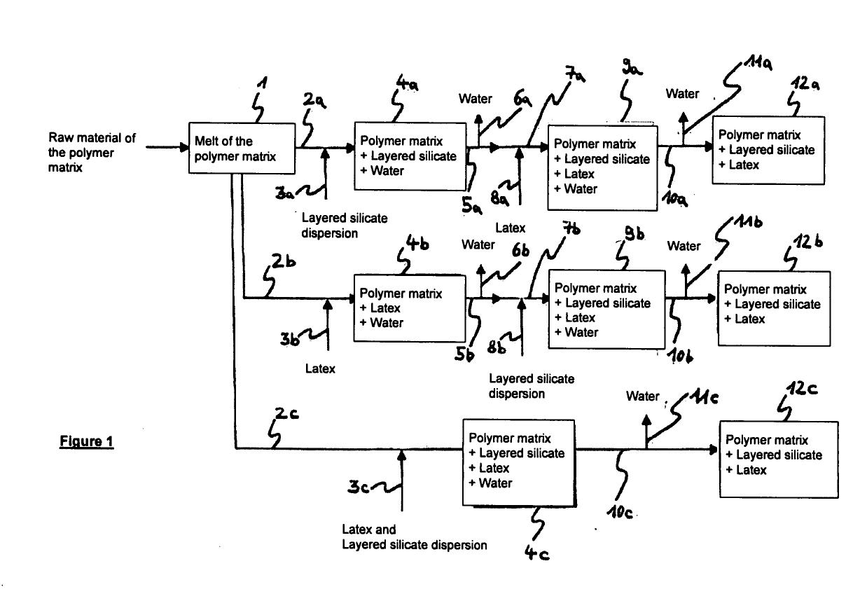

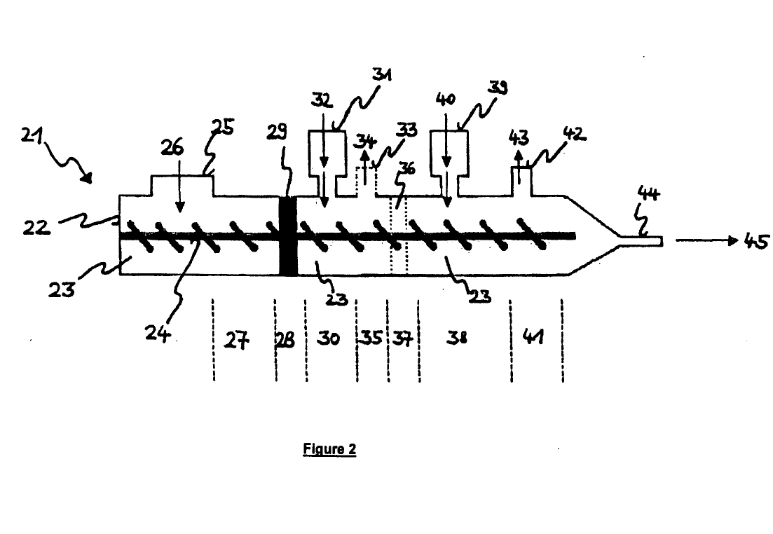

Further advantages, features and application possibilities of the present invention become clear with the help of FIGS. 1 and 2. There are shown in detail in:

FIG. 1 a flowchart of an extrusion process according to the invention for the preparation of toughness-modified and layered silicate-reinforced thermoplastic systems and

FIG. 2 a schematic representation of a cross-section through an extrusion device for the preparation according to the invention of toughness-modified and layered silicate-reinforced thermoplastic systems.

FIG. 1 shows the sequence of the compounding of the individual starting materials in a preparation process according to the invention for the production of toughness-modified and layered silicate-reinforced thermoplastic systems in a flowchart. The raw material of the polymer matrix (for example granules of the polymer matrix material) is firstly melted in a melting device 1. There are then various possibilities for adding the other composite components to the system. In the process which is represented in the topmost branch of the flowchart of FIG. 1, the layered silicate is firstly added in aqueous dispersion to the melt of the polymer matrix in the admixing stage 2a via the admixing device 3a. The mixture emerging from this consists of the polymer matrix, the layered silicate and water and is homogenized in the mixing device 4a. At this process level water can optionally be removed from the system in a drainage step 5a via the drainage device 6a. With or without this step, in the following admixing stage 7a the addition of latex via the admixing device 8a takes place, and the resulting mixture thus consists of the polymer matrix, the layered silicate, the latex and water which is homogenized again in the mixing device 9a. In the following drainage step 10a water is removed via the drainage device 11a from the compounding system and the compound emerging from same substantially comprises the polymer matrix with the layered silicate and latex and is optionally further homogenized by the delivery device 12a or further homogenized and the product finally delivered. In another embodiment of a process according to the present invention latex and layered silicate dispersions are added in reverse order to the polymer matrix melt. Such an embodiment is represented in the middle branch of the flowchart in FIG. 1. Accordingly in the admixing stage 2b latex is initially added in a first step to the polymer matrix melt via the admixing device 3b. The mixture emerging from same consists of the polymer matrix, the latex and water and is homogenized in the mixing device 4b. At this process level water can optionally be removed from the system via the drainage device 6b in a drainage step 5b. With or without this step, in the following admixing stage 7b the addition of layered silicate in aqueous dispersion via the admixing device 8b takes place, and thus the mixture resulting therefrom consists of the polymer matrix, the layered silicate, the latex and water, which is homogenized again in the mixing device 9b. In the following drainage step 10b water is removed via the drainage device 11b from the compounding system and the compound emerging from same substantially comprises the polymer matrix with the layered silicate and latex and is optionally further homogenized by the delivery device 12b and the product finally delivered. A third embodiment of the present invention is represented in the lowermost branch of the flowchart of FIG. 1. In this case the addition of latex and layered silicate dispersion takes place jointly in an admixing stage 2c via the mixing device 3c. The mixture emerging from same consists of the polymer matrix, the layered silicate, latex and water and is homogenized in the mixing device 4c. Here also, after the removal of water from the mixture in the drainage step 10c via the drainage device 11c, a compound is obtained which substantially comprises the polymer matrix, layered silicate and latex.

In FIG. 2 a top view onto a lateral cross-section through an extrusion device 21 for the preparation according to the invention of toughness-modified and layered silicate-reinforced thermoplastic systems is represented. This device is substantially formed by an elongated cylindrical tube 22, in the inside 23 of which is found a screw 24 which extends substantially continuously over almost the entire length of the cylindrical tube 22, wherein the cross-section of the tube can, however, also vary over its entire length in order to be able to provide zones of higher or lower pressure. The transport movement of the screw takes place expediently from left to right. A filling device 25 for the material(s) of the polymer matrix 26 is located on the left-hand side. These materials, introduced for example in the form of granules, are melted inter alia by the shearing movement of the screw 24 in the melting zone 27 of the device. The melt is transported by the transport movement of the screw 24 from left to right out of the melting zone 27 through the boundary zone 28 into the compounding zone 30. The screw 24 in the boundary zone 28 passes a sealing element 29. The sealing element 29 prevents the melt from flowing back against the transport direction of the screw 24. The sealing element 29 is generally a steel disk whose outer periphery is somewhat less than the inner periphery of the cylindrical tube and through whose opening the melt can flow as before, wherein the return flow of the melt against the transport direction of the screw is clearly reduced. A further possibility of the separation of the zones 27 and 30 by the boundary zone 28 is a special screw configuration with formation of a compression segment. In the embodiment represented here a filling device 31 for introducing layered silicate in aqueous dispersion 32 is located in the compounding zone 30. An evaporation zone 35 is optionally conceivable next to this zone, in which excess gas 34 can be removed via the evaporation device 33. If such an evaporation zone 35 is realized, a further boundary zone 37 would be advantageous, providing a sealing element 36 (analogous to the sealing element 29). Located in the adjoining second compounding zone 38 is a further filling device 39 for introducing latex 40 into the compounding system in the compounding zone 38. The mixture of polymer matrix, layered silicate dispersion and latex is thoroughly mixed and homogenized in the compounding zone 38 by the movement of the screw 24. Simultaneously there is a further transport of the compound mixture from left to right through the extrusion device 21. Located adjoining the compounding zone 38 in the case of the extrusion device according to the invention represented here is the evaporation zone 41, in which excess gases 43, largely water vapour, can be removed via the evaporation device 42. The evaporated compound 45 is there conveyed outwards from the extrusion device 21 by the transport movement of the screw 24 through the delivery nozzle 44.

In addition to the details from the above description and the corresponding Figures, further features, advantages and application possibilities of the present invention result from the following examples:

### EXAMPLE 1 (E1) AND COMPARISON EXAMPLE 1 (C1)

A nanocomposite based on polyamide 6 (Ultramid B3, BASF AG, Germany, abbreviation: PA-6) was prepared on a twin-screw extruder (ZSE, Werner & Pfleiderer, Germany). A natural Na-bentonite (EXM 757, Süd-Chemie, Germany, abbreviation: B) was used as layered silicate. A NBR-Latex (Perbunan N Latex 1120, Polymerlatex GmbH, Germany), solids content 45 wt.-%, was used for the toughness modification. The rubber content was set at 5 wt.-%, and the layered silicate content of the finished compound at 1 wt.-%, by separate dosing of respectively the latex and the aqueous dispersion of the layered silicate. The instructions of the PA-6 manufacturer were followed for process control (temperature pattern, torque of the screws etc.) The evaporation of the water as “carrier material” took place through a vent in the extruder cylinder. This was also encouraged by the screw configuration (incorporated decompression segment). The residence time in the extruder was approx. 8 min. The product thus prepared by the “latex route” was granulated and then injection moulded (E1). For comparison tests, mixtures with the same composition were prepared by adding the same NBR in solid state and by powder dosing of the layered silicates via the “melt route” (C1). The mechanical properties were measured on injection-moulded samples using the respective standards (i.e. tensile characteristics according to DIN EN ISO 527 for samples of type 1A, notched impact strength according to DIN EN ISO 179). Because of the hygroscopic nature of PA-6 the samples to be examined were conditioned (according to DIN EN ISO 291 at 23° C. and 50 rel. humidity). The results are summarized in Table 1.

TABLE 1

| | | | Tensile | | Notched impact |
|---|---|---|---|---|---|
| | | | E-modulus | Strength | strength (23° C.) |
| | Composition | Preparation | [GPa] | [Mpa] | [kJ/m²] |
| E1 | PA-6/NBR/B | Latex route | 2.2 | 72.5 | 11.8 |
| C1 | 94/5/1 | Melt route | 2.0 | 50.1 | 8.1 |

### EXAMPLE 2 (E2) AND COMPARISON EXAMPLE 2 (C2)

A nanocomposite was prepared analogously to Example 1 on a twin-screw extruder (ZSE, Werner & Pfleiderer, Germany), wherein a synthetic Na-fluorohectorite (Somasif ME-100, Coop Chemicals, Japan, abbreviation: F) was chosen as layered silicate. Here the rubber content was set at 35 wt.-%, and the layered silicate content of the finished compound at 10 wt.-%, by separate dosing of respectively the latex and the aqueous dispersion of the layered silicate. Process control, evaporation, screw configuration and residence time were likewise chosen as in Example 1. The product thus prepared by the “latex route” was granulated and then injection moulded (E2). For comparison tests, mixtures with the same composition were prepared by adding the same NBR in solid state and by powder dosing of the layered silicates via the “melt route” (C2). The mechanical properties were ascertained as for Example 1 and Comparison Example 1. The results are summarized in Table 2.

TABLE 2

| | | | Tensile | | Notched impact |
|---|---|---|---|---|---|
| | | | E-modulus | Strength | strength (23° C.) |
| | Composition | Preparation | [GPa] | [MPa] | [kJ/m²] |
| E2 | PA-6/NBR/F | Latex route | 1.7 | 38.7 | No break |
| C2 | 55/35/10 | Melt route | 1.3 | 23.1 | 13.1 |

### EXAMPLE 3 (E3) AND COMPARISON EXAMPLE 3 (C3)

A nanocomposite based on polybutylene terephthalate (Ultradur B4520, BASF AG, Germany, abbreviation: PBT) was prepared as described in Example 1, wherein in this case an acrylate latex (Plextol X 4324, Polymerlatex GmbH, Germany, abbreviation ACR) with 60 wt.-% solids content was used for the toughness modification. The layered silicate (bentonite, B) was dispersed in the latex before it was added to the PBT. This necessitated a post-stabilization of the ACR latex, which was achieved by adding cationic surfactants (in this case cetyl-trimethyl-ammonium-bromide in 1.0 wt.-%) and by a blending with polar organic solvent (in this case ethyl alcohol/polyethylene glycol: 2/1). The organic solvent content of the added dispersion was 45 vol.-% overall. The composition of the mixtures was as follows: PBT/rubber/layered silicate=86/10/4 (E3, latex route). For comparison purposes (C3, melt route), the rubbers which were obtained by precipitation (coagulation) from the same latex as in E3 were used. The mechanical properties were ascertained as in Example 1—but without conditioning of the samples—and are summarized in Table 3.

TABLE 3

| | | | Tensile | | Notched impact |
|---|---|---|---|---|---|
| | | | E-modulus | Strength | strength (23° C.) |
| | Composition | Preparation | [GPa] | [MPa] | [kJ/m²] |
| E3 | PBT/ACR/B | Latex route | 2.9 | 75.5 | 4.5 |
| C3 | 86/10/4 | Melt route | 2.1 | 48.1 | 2.9 |

### EXAMPLE 4 (E4) AND COMPARISON EXAMPLE 4 (C4)

Example 4 was carried out analogously to Example 3, wherein in this case a polymer dispersion (average particle size: 0.5 μm) with particles of a core (polystyrene)/shell (polyacrylate) structure (abbreviation: AC-KS) was used for the toughness modification. The polystyrene/polyacrylate-ratio was 65/35 wt.-%. Here the layered silicate (bentonite, B) was dispersed in the polymer dispersion before it was added to the PBT. (E4). For comparison purposes (C4), the rubbers which were obtained by precipitation (coagulation) from the same dispersion as in E4 were used. The mechanical properties were ascertained as in Example 1—but without conditioning of the samples—and are summarized in Table 4.

TABLE 4

| | | | Tensile | | Notched impact |
|---|---|---|---|---|---|
| | | | E-modulus | Strength | strength (23° C.) |
| | Composition | Preparation | [GPa] | [MPa] | [kJ/m²] |
| E4 | PBT/ | Latex route | 3.1 | 71.9 | 4.0 |
| | AC-KS/B | | | | |
| C4 | 86/10/4 | Melt route | 2.3 | 40.1 | 2.1 |

### EXAMPLE 5 (E5) AND COMPARISON EXAMPLE 5 (C5)

A polyoxymethylene of the injection-moulding type (Hostaform C9021, Ticona GmbH, Germany, abbreviation: POM) was prepared analogously to Example 1 and refined here by adding Na-fluorohectorite (F) and polyester urethane latex (Impranil DLP-R, Bayer AG, Germany, rubber content: 50 wt.-%, abbreviation: PUR). The following composition was used via the “latex route”: POM/PUR/F=94/5/1 (E5). For comparison purposes, the same compound was prepared via the “melt route” (C5). For this, the PUR was obtained from the latex by freeze-drying. The results are listed in Table 5.

TABLE 5

| | | | Tensile | | Notched impact |
|---|---|---|---|---|---|
| | | | E-modulus | Strength | strength (23° C.) |
| | Composition | Preparation | [GPa] | [MPa] | [kJ/m²] |
| E5 | POM/PUR/F | Latex route | 2.9 | 66.5 | 6.7 |
| C5 | 94/5/1 | Melt route | 2.8 | 51.1 | 4.8 |

### EXAMPLE 6 (E6) AND COMPARISON EXAMPLE 6 (C6)

A nanocomposite based on POM was prepared analogously to Example 5, wherein here the following composition was used via the “latex route”: POM/PUR/F=80715/5 (E6). For comparison purposes, the same compound was also prepared via the “melt route” (C6). For this, the PUR was obtained from the latex by freeze-drying. The results are listed in Table 6.

TABLE 6

| | | | Tensile | | Notched impact |
|---|---|---|---|---|---|
| | | | E-modulus | Strength | strength (23° C.) |
| | Composition | Preparation | [GPa] | [MPa] | [kJ/m²] |
| E6 | POM/PUR/F | Latex route | 2.2 | 57.8 | 11.0 |
| C6 | 80/15/5 | Melt route | 2.0 | 40.0 | 5.9 |

### EXAMPLE 7 (E7) AND COMPARISON EXAMPLE 7 (C7)

A nanocomposite was prepared analogously to Example 1, wherein an isotactic polypropylene homopolymer (Hostalen PPH 2150, Basell, Germany, abbreviation: PP) with a high-ammonium-content natural rubber latex (Rubber Research Institute, India, abbreviation: NR) and Na-bentonite was refined. The NR content of the latex was 60 wt.-%. The following composition was prepared by extrusion: PP/NR/bentonite (B)=93/5/2 (E7). For comparison purposes, the melt-compounded mixture which was prepared using solid NR (SMR-CV) and powder dosing of B (C7) was used. The results are listed in Table 7.

TABLE 7

| | | | Tensile | | Notched impact |
|---|---|---|---|---|---|
| | | | E-modulus | Strength | strength (−30° C.) |
| | Composition | Preparation | [GPa] | [MPa] | [kJ/m²] |
| E7 | PP/NR/B | Latex route | 1.35 | 33.0 | 4.1 |
| C7 | 93/5/2 | Melt route | 1.20 | 28.1 | 2.3 |

### EXAMPLE 8 (E8) AND COMPARISON EXAMPLE 8 (C8)

A nanocomposite was prepared analogously to Example 7, wherein the following composition was extruded: PP/NR/bentonite(B)=81/15/4 (E8). For comparison purposes, the melt-compounded mixture which was prepared using solid NR (SMR-CV) and powder dosing of B (C8) was used. The results are listed in Table 8.

TABLE 8

| | | | Tensile | | Notched impact |
|---|---|---|---|---|---|
| | | | E-modulus | Strength | strength (−30° C.) |
| | Composition | Preparation | [GPa] | [MPa] | [kJ/m²] |
| E8 | PP/NR/B | Latex route | 1.10 | 29.0 | 7.6 |
| C8 | 81/15/4 | Melt route | 0.95 | 20.9 | 3.1 |

### EXAMPLE 9 (E9) AND COMPARISON EXAMPLE 9 (C9)

A nanocomposite was prepared analogously to Example 8, wherein the latex was prevulcanized here (NR-P). For the prevulcanization, zinc-diethyl-dithiocarbamate and sulphur were added to the latex in aqueous dispersion, each in 1 part by weight per 100 parts by weight of dry NR, and the temperature was then increased to 70° C. After 4 hours' storage the latex was cooled to room temperature and the earlier ammonium content restored. The following composition was prepared by extrusion: PP/NR-P/bentonite(B)=81/15/4 (E9). For comparison purposes the melt-compounded mixture which was prepared using solid NR (SMR-CV) and powder dosing of B (C9) was used. The results are listed in Table 9, wherein the PP/NR-P/B=81/15/4 mixture was not able to be produced homogeneously via the “melt route” and therefore the characteristic mechanical values for this in Table 8 are missing.

TABLE 9

| | | | Tensile | | Notched impact |
|---|---|---|---|---|---|
| | | | E-modulus | Strength | strength (−30° C.) |
| | Composition | Preparation | [GPa] | [MPa] | [kJ/m²] |
| E9 | PP/NR/B | Latex route | 1.25 | 29.0 | 10.2 |

| | | | |
|---|---|---|---|
| C9 | 81/15/4 | Melt route | Mixture is non-homogenous |

### EXAMPLE 10 (E10) AND COMPARISON EXAMPLE 10 (C10)

Analogously to Examples 7, 8 and 9, PP was refined both without prevulcanization (NR) and with prevulcanization (NR-P). The following composition was prepared by extrusion: PP/NR(-P)/bentonite(B)=50/40/10 (E10a+b). For comparison purposes, the melt-compounded mixture which was prepared using solid NR (SMR-CV) and powder dosing of B (C10a+b) was used. The 50/40/10 mixture displayed the properties profile of a thermoplastic elastomer and was therefore characterized differently than hitherto. To determine the properties of the PP/NR(-P)/B=50/40/10 mixture, the compression set (CS according to DIN 53517, 70° C., 22 hours) was used. The results are listed in Table 10, wherein it is to be noted that a CS value of 100% corresponds to an ideal thermoplast and a CS value of 0% to an ideal rubber.

TABLE 10

| | Composition | Preparation | CS [%] |
|---|---|---|---|
| E10a | PP/NR-P/B | Latex route | 37 |
| V10a | (50/40/10) | Melt route | 59 |
| E10b | PP/NR/B | Latex route | 42 |
| C10b | (50/40/10) | Melt route | 66 |

### LIST OF REFERENCE NUMBERS

1 melting device
2a-c admixing stage
3a-c admixing device
4a-c mixing device
5a-c drainage step
6a-c drainage device
7a-c admixing stage
8a-c admixing device
9a-c mixing device
10a-c drainage step
11a-c drainage device
12a-c delivery device
21 extrusion device
22 cylindrical tube
23 inside of the cylindrical tube
24 screw
25 filling device
26 materials of the polymer matrix
27 melting zone
28 boundary zone
29 sealing element
30 compounding zone
31 filling device
32 layered silicate in aqueous dispersion
33 evaporation device
34 excess gas (water vapour)
35 evaporation zone
36 sealing element
37 boundary zone
38 compounding zone
39 filling device
40 latex
41 evaporation zone
42 evaporation device
43 excess gases (water vapour)
44 delivery nozzle
45 evaporated compound

1. Extrusion process for the preparation of toughness-modified and layered silicate-reinforced thermoplastic systems, characterized in that both toughness modifier and layered silicate are introduced in substantially aqueous dispersion into the compounding system and that the water from the compounding system is at least partly removed during the extrusion.

2. Extrusion process according to claim 1, characterized in that the dispersions of toughness modifier and layered silicate are introduced separately into the compounding system.

3. Extrusion process according to claim 1, characterized in that the dispersions of toughness modifier and layered silicate are introduced together into the compounding system.

4. Extrusion process according to one of claims 1 to 3, characterized in that the water is at least partly removed from the compounding system by evaporation during the extrusion.

5. Extrusion process according to one of claims 1 to 3, characterized in that the toughness modifiers used include natural and synthetic rubber and mixtures thereof.

6. Extrusion process according to one of claims 1 to 3, characterized in that the toughness modifiers used include latex and latex mixtures.

7. Extrusion process according to claim 6, characterized in that the latex or the latex mixture or the rubber or the rubber mixture is prevulcanized.

8. Extrusion process according to one of claims 1 to 3, characterized in that the toughness modifier used has a particle size of 0.1-10 μm, preferably approximately 0.5 μm.

9. Extrusion process according to one of claims 1 to 3, characterized in that the structure of the particles of the toughness modifier consists of a core and a shell.

10. Extrusion process according to one of claims 1 to 3, characterized in that the particles of the toughness modifier have reactive groups on their surface.

11. Extrusion process according to one of claims 1 to 3. characterized in that the toughness modifier used is contained in the compounded product of the process in an amount of 1-40 wt.-%, preferably in an amount of 5-35 wt.-%.

12. Extrusion process according to one of claims 1 to 3, characterized in that the layered silicate used includes natural and synthetic layered silicates which are swellable with water, preferably Na-bentonite or Na-fluorohectorite.

13. Extrusion process according to one of claims 1 to 3, characterized in that the layered silicate is contained in the compounded product of the process in an amount of 1-10 wt.-%, preferably an amount of 4-8 wt.-%.

14. Extrusion process according to one of claims 1 to 3, characterized in that the substantially aqueous dispersion additionally contains up to 50 vol.-% of polar, water-soluble organic compounds, which include alcohols, glycols and water-soluble polymers.

15. Extrusion process according to one of claims 1 to 3, characterized in that cationic surfactants are added to the dispersion to post-stabilize the latex.

16. Extrusion process for the preparation of toughness-modified and layered silicate-reinforced thermoplastic systems, characterized in that both toughness modifier and layered silicate are introduced in substantially aqueous dispersion into the compounding system and that the water from the compounding system is at least partly removed during the extrusion;
(a) characterized in that the water is at least partly removed from the compounding system by evaporation during the extrusion; and
(b) characterized in that the toughness modifiers used include natural and synthetic rubber and mixtures thereof.

17. Extrusion process for the preparation of toughness-modified and layered silicate-reinforced thermoplastic systems, characterized in that both toughness modifier and layered silicate are introduced in substantially aqueous dispersion into the compounding system and that the water from the compounding system is at least partly removed during the extrusion;
(a) characterized in that the water is at least partly removed from the compounding system by evaporation during the extrusion; and
(b) characterized in that the toughness modifiers used include latex and latex mixtures.
